(19) United States
(12) Patent Application Publication
(10) Pub. No.: US 2011/0001725 A1
(43) Pub. Date: Jan. 6, 2011

(54) TOUCH PANEL AND DRIVING METHOD THEREOF

(75) Inventor: Yoshiyuki Kurokawa, Sagamihara (JP)

Correspondence Address: FISH & RICHARDSON P.C. (DC), P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 12/828,910

(22) Filed: Jul. 1, 2010

(30) Foreign Application Priority Data
Jul. 2, 2009 (JP) 2009-157474

(51) Int. Cl. G06F 3/045; G06F 3/041; G09G 3/36; G09G 3/32

(52) U.S. Cl. 345/174; 345/173; 345/176; 345/82; 345/88

(57) ABSTRACT

An object of one embodiment of the present invention is to provide an inexpensive touch panel capable of color imaging with high resolution. A touch panel includes a panel including a first substrate and a second substrate opposed to each other, and a plurality of light sources sequentially or concurrently provides, from the first substrate side, lights of different wavelength regions to the panel. A plurality of pixels each including a liquid crystal element, a photodiode, and a thin film transistor is provided between the first substrate and the second substrate. An island shaped semiconductor film included in the photodiode and an island shaped semiconductor film included in the thin film transistor are formed by etching one semiconductor film over the second substrate.

### BACKGROUND OF THE INVENTION

1. Field of the Invention

The present invention relates to a touch panel including a touch sensor and to a method of driving the touch panel. In particular, the present invention relates to a touch panel in which pixels each provided with a touch sensor are arranged in matrix and to a method of driving the touch panel. Further, the present invention relates to electronic devices including the touch panel.

2. Description of the Related Art

In recent years, display devices provided with touch sensors have attracted attention. Display devices provided with touch sensors are called touch panels, touch screens, or the like (hereinafter referred to simply as touch panels). Touch sensors are classified by principle of operation under resistive touch sensors, capacitive touch sensors, optical touch sensors, and the like. In any of the sensors, data can be input when an object is in contact with a display device or in the vicinity of the display device.

Providing, in a touch panel, a sensor that detects light (the sensor also referred to as a “photosensor”) as an optical touch sensor makes a display screen also serve as an input region. One example of a device including such an optical touch sensor is a display device having a function of capturing images, which is achieved by contact area sensors arranged that capture images (e.g., see Patent Document 1). As for a touch panel including an optical touch sensor, light is emitted from a touch panel. When an object exists at a predetermined position of the touch panel, light at the region where the object exists is blocked by the object, and part of the light is reflected. A photosensor (also referred to as a photoelectric conversion element) which can detect light is provided in a pixel of the touch panel, and the photosensor recognizes the existence of the object in the region where the light is detected by detecting the reflected light.

In addition, it has been attempted to give a personal authentication function or the like to an electronic device such as a mobile phone or a portable information terminal (e.g., see Patent Document 2). A finger print, a face, a hand print, a palm print, a hand vein pattern, and the like are used for personal authentication. When the personal authentication function is provided in a portion different from the display portion, the number of components is increased, and the weight or the price of the electronic device may be increased.

In addition, in a touch sensor system, a technique to select an image processing mode for detecting the position of a fingertip according to the brightness of outside light is known (e.g., see Patent Document 3).

### [Reference]

[Patent Document 1] Japanese Published Patent Application No. 2001-292276

[Patent Document 2] Japanese Published Patent Application No. 2002-033823

[Patent Document 3] Japanese Published Patent Application No. 2007-183706

### SUMMARY OF THE INVENTION

When a touch panel is used for an electronic device having a personal authentication function, it is necessary to collect electrical signals that photosensors each provided in each pixel of the touch panel generate by detecting light and to perform image processing. In particular, photosensors need to have higher sensitivity in order to realize electronic devices having a personal authentication function with high resolution and high speed operation. In addition, in order to realize a high level of personal authentication function, it is necessary to collect data not in monochrome but in color. Further, it is necessary to provide an inexpensive touch panel.

In view of the above problems, an object of one embodiment of the present invention disclosed is to provide an inexpensive touch panel including a photosensor with high sensitivity and having a color imaging function, and to provide a method of driving the touch panel.

A touch panel according to one embodiment or the present invention includes, in each pixel, a display element and a photosensor. A photodiode included in the photosensor and a thin film transistor included in the display element are formed of the same semiconductor film. Backlight is shone from a counter substrate side and an object is placed on a TFT substrate side. Particular colors of light sources included in the backlight are sequentially lit. During the particular color of light source is lit, reflected light from the object is detected by the photosensor to make image data of the color. Image data of all of the colors provide a color image. In addition, in a touch panel according to one embodiment of the present invention, a shielding film of the photodiode is formed of a conductive film that is used for a gate electrode of the thin film transistor.

### Effect of the Invention

The present invention can provide an inexpensive touch panel capable of color imaging with high resolution. The present invention can provide a driving method of an inexpensive touch panel capable of color imaging with high resolution.

### BRIEF DESCRIPTION OF THE DRAWINGS

FIG. 1 illustrates the structure of a touch panel.

FIG. 2 illustrates the structure of the touch panel.

FIG. 3 illustrates the structure of the touch panel.

FIG. 4 is a timing chart.

FIG. 5 is the cross-sectional view of the touch panel.

FIG. 6 is the cross-sectional view of a touch panel.

FIG. 7 is a timing chart.

FIG. 8 illustrates the structure of a touch panel.

FIGS. 9A to 9E each illustrate an example of an electronic device to which a touch panel is applied.

### DETAILED DESCRIPTION OF THE INVENTION

Hereinafter, embodiments of the present invention will be described in detail 10 with reference to the drawings. However, since embodiments described below can be embodied in many different modes, it is easily understood by those skilled in the art that the mode and the detail can be variously changed without departing from the spirit and the scope of the present invention. Therefore, the present invention is not construed as being limited to the following description. In the drawings for explaining the embodiments, the same parts or parts having similar functions are denoted by the same reference numerals, and description thereof is not repeated.

### Embodiment 1

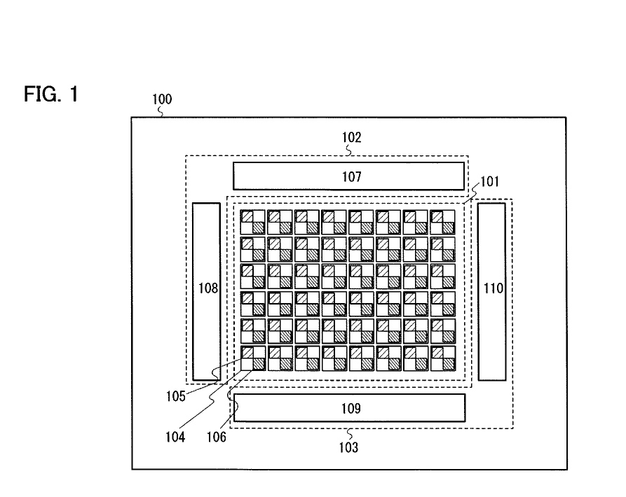

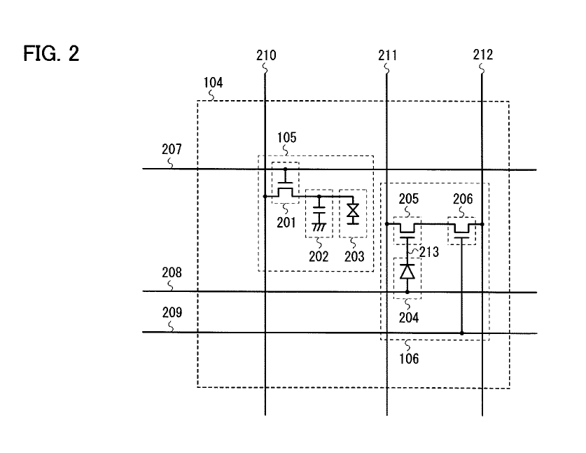

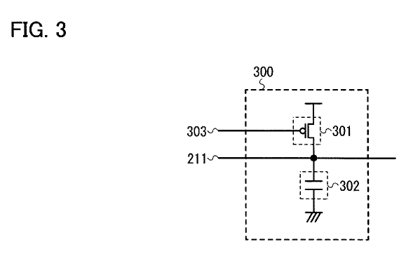

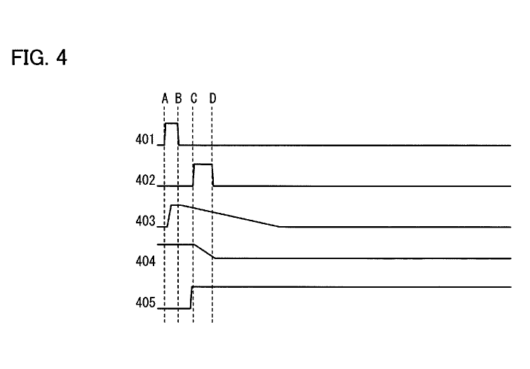

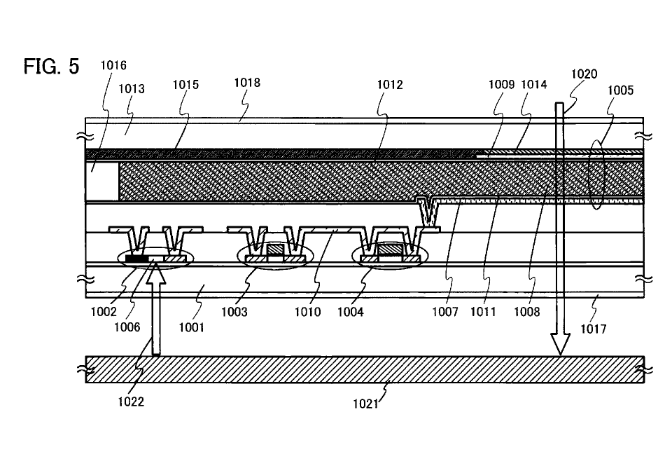

In this embodiment, a touch panel will be described with reference to FIG. 1, FIG. 2, FIG. 3, FIG. 4, and FIG. 5.

The structure of the touch panel will be described with reference to FIG. 1. A touch panel 100 includes a pixel circuit 101, a display element control circuit 102, and a photosensor control circuit 103. The pixel circuit 101 includes a plurality of pixels 104 arranged in a matrix of rows and columns. Each of the pixels 104 includes a display element 105 and a photosensor 106.

Each of the display elements 105 includes a thin film transistor (TFT), a storage capacitor, a liquid crystal element including a liquid crystal layer, and the like. The thin film transistor has the function of controlling injection or ejection of charge to/from the storage capacitor. The storage capacitor has the function of storing charge whose amount is equivalent to the amount of voltage applied to the liquid crystal layer. The contrast (gray scale) of light passing through the liquid crystal layer is made by utilizing the change in the direction of a polarization, which is due to a voltage application to the liquid crystal layer; in this manner, image display is realized. Light that a light source (a backlight) emits from the rear side of a liquid crystal display device is used to be passed through the liquid crystal layer.

Note that methods of displaying color images include a method in which a color filter is used, that is, a color filter method. This method makes it possible to produce the gray scale of a particular color (e.g., red (R), green (G), or blue (B)) when light that has passed through the liquid crystal layer passes through a color filter. Here, when the color filter method is employed, the pixel 104 that has the function of emitting red (R) light, the pixel 104 that has the function of emitting green (G) light, and the pixel 104 that has the function of emitting blue (B) light are called an R pixel, a G pixel, and a B pixel, respectively.

Methods of displaying color images also include a method in which respective light sources of particular colors (e.g., red (R), green (G), and blue (B)) are used as a backlight, and are sequentially lit, that is, a field-sequential method. In the field-sequential method, the gray scale of each of the colors can be given by making the contrast of light passing through the liquid crystal layer while the light source thereof is turned on.

Although the case where the display elements 105 include liquid crystal elements is described, it is also acceptable that the display elements 105 include other elements such as light emitting elements. Light emitting elements are elements whose luminance is controlled by current or voltage; specifically, light emitting elements include light emitting diodes, OLEDs (organic light emitting diodes), and the like.

The photosensor 106 includes an element such as a photodiode, which has the function of generating an electric signal by receiving light, and a thin film transistor. Note that reflected light that occurs when light from the backlight is shone on an object can be utilized to be received by the photosensors 106.

The display element control circuit 102 is a circuit for controlling the display elements 105 and includes a display element driver circuit 107 which inputs a signal to the display elements 105 via signal lines (also referred to as source signal lines) such as video-data signal lines; and a display element driver circuit 108 which inputs a signal to the display elements 105 via scanning lines (also referred to as gate signal lines). For example, the display element driver circuit 108 for driving the scanning line has the function of selecting the display elements included in the pixels placed in a particular row. The display element driver circuit 107 for driving the signal line has the function of applying a predetermined potential to the display elements included in the pixels placed in a selected row. Note that in the display element to which the display element driver circuit 108 for driving the scanning line applies high potential, the thin film transistor is conducting state, so that the display element is provided with charge from the display element driver circuit 107 for driving the signal line.

The photosensor control circuit 103 is a circuit for controlling the photosensors 106 and includes a photosensor reading circuit 109 for driving a signal line such as a photosensor output-signal line or a photosensor reference signal line; and a photosensor driver circuit 110 for driving the scanning line. For example, the photosensor driver circuit 110 for driving the scanning line has the function of selecting the photosensors 106 included in the pixels placed in a predetermined row. The photosensor reading circuit 109 for driving the signal line has the function of extracting an output signal of the photosensors 106 included in the pixels in a selected row. Note that the photosensor reading circuit 109 for driving the signal line can have a system in which an output, which is an analog signal, of the photosensor is extracted as an analog signal to the outside of the touch panel by an OP amplifier; or a system in which the output is converted into a digital signal by an A/D converter circuit and then extracted to the outside of the touch panel.

A circuit diagram of the pixel 104 will be described with reference to FIG. 2. The pixel 104 includes the display element 105 including a transistor 201, a storage capacitor 202, and a liquid crystal element 203; and the photosensor 106 including a photodiode 204, a transistor 205, and a transistor 206.

In the transistor 201, a gate is electrically connected to a gate signal line 207, one of a source and a drain is electrically connected to a video-data signal line 210, and the other one of the source and the drain is electrically connected to one electrode of the storage capacitor 202 and one electrode of the liquid crystal element 203. The other electrode of the storage capacitor 202 and the other electrode of the liquid crystal element 203 are each held at a certain potential. The liquid crystal element 203 includes a pair of electrodes and a liquid crystal layer sandwiched between the pair of electrodes.

When a potential “H” (a potential at a high level) is applied to the gate signal line 207, the transistor 201 supplies a potential of the video-data signal line 210 to the storage capacitor 202 and the liquid crystal element 203. The storage capacitor 202 holds the potential applied. The liquid crystal element 203 changes light transmittance in accordance with the potential applied.

In the photodiode 204, one electrode is electrically connected to a photodiode reset signal line 208, and the other electrode is electrically connected to a gate of the transistor 205. In the transistor 205, one of a source and a drain is electrically connected to a photosensor output signal line 211, and the other one of the source and the drain is electrically connected to one of a source and a drain of the transistor 206. In the transistor 206, a gate is electrically connected to a gate signal line 209, and the other one of the source and the drain is electrically connected to a photosensor reference signal line 212.

Next, the structure of the photosensor reading circuit 109 will be described with reference to FIG. 3. In FIG. 3, a photosensor reading circuit 300 for one column of pixels includes a p-type TFT 301 and a storage capacitor 302. Further, the photosensor reading circuit 300 includes a photosensor output signal line 211 and a precharge-signal line 303 which are for the one column of pixels.

In the photosensor reading circuit 300, the potential of the photosensor output signal line 211 is set at a reference potential before the operation of the photosensor in the pixel. In FIG. 3, the potential of the precharge-signal line 303 is set at a potential “L” (a potential at a low level), thereby setting the potential of the photosensor output signal line 211 at a high potential which is the reference potential. Note that it is acceptable that the storage capacitor 302 is not provided if the photosensor output signal line 211 has large parasitic capacitance. Note that the reference potential can be a low potential. In this case, the use of an n-type TFT makes the potential of the precharge-signal line 303 “H”, thereby setting the potential of the photosensor output signal line 211 at a low potential which is the reference potential.

Next, a reading operation of the photosensor of the touch panel will be described with reference to a timing chart in FIG. 4. In FIG. 4, a signal 401 corresponds to the potential of the photodiode reset signal line 208 in FIG. 2, a signal 402 corresponds to the potential of the gate signal line 209 in FIG. 2 to which the gate of the transistor 206 is connected, a signal 403 corresponds to the potential of a gate signal line 213 in FIG. 2 to which the gate of the transistor 205 is connected, and a signal 404 corresponds to the potential of the photosensor output signal line 211 in FIG. 2. Further, a signal 405 corresponds to the potential of the precharge-signal line 303 in FIG. 3.

At a time A, when the potential of the photodiode reset signal line 208 (the signal 401) is set at “H”, the photodiode 204 conducts, and the potential of the gate signal line 213 (the signal 403) to which the gate of the transistor 205 is connected becomes “H”. Further, when the potential of the precharge signal line 303 (the signal 405) is set at “L”, the potential of the photosensor output signal line 211 (the signal 404) is precharged to “H”.

At a time B, when the potential of the photodiode reset signal line 208 (the signal 401) is set at “L”, the potential of the gate signal line 213 (the signal 403) to which the gate of the transistor 205 is connected starts to be lowered because of off current of the photodiode 204. The off current of the photodiode 204 increases when light is shone thereon; therefore, the potential of the gate signal line 213 (the signal 403) to which the gate of the transistor 205 is connected varies in accordance with the amount of the light shone on the photodiode 204. That is, a source-drain current of the transistor 205 varies.

At a time C, when the potential of the gate signal line 209 (the signal 402) is set at “H”, the transistor 206 conducts, and electrical continuity between the photosensor reference signal line 212 and the photosensor output signal line 211 is established via the transistor 205 and the transistor 206. Then, the potential of the photosensor output signal line 211 (the signal 404) gets lower and lower. Note that previous to the time C, the potential of the precharge signal line 303 (the signal 405) is set at “H” and the precharge of the photosensor output signal line 211 is completed. Here, a speed with which the potential of the photosensor output signal line 211 (the signal 404) is lowered depends on the source-drain current of the transistor 205. That is, the speed varies in accordance with the amount of light shone on the photodiode 204.

At a time D, when the potential of the gate signal line 209 (the signal 402) is set at “L”, the transistor 206 is turned off, and the potential of the photosensor output signal line 211 (the signal 404) has a constant value from the time D. Here, the value as the constant value varies in accordance with the amount of light shone on the photodiode 204. Therefore, the amount of light shone on the photodiode 204 can be found by obtaining the potential of the photosensor output signal line 211.

FIG. 5 illustrates an example of a cross-sectional view of the touch panel. In the touch panel in FIG. 5, a photodiode 1002, a transistor 1003, a storage capacitor 1004, and a liquid crystal element 1005 are provided over a substrate (TFT substrate) 1001 having an insulating surface.

The photodiode 1002 and the storage capacitor 1004 can be formed at the same time as the transistor 1003 in a process of manufacturing the transistor 1003. The photodiode 1002 is a lateral PIN diode. A semiconductor film 1006 included in the photodiode 1002 includes a region that has p-type conductivity (p-type layer), a region that has i-type conductivity (i-type layer), and a region that has n-type conductivity (n-type layer). Note that although the case where the photodiode 1002 is a PIN diode is shown as an example in this embodiment, the photodiode 1002 may be a PN diode instead. It is possible to form a lateral PIN or PN diode by adding a p-type impurity and an n-type impurity to respective particular regions of the semiconductor film 1006.

Further, it is possible to form an island-shaped semiconductor film of the photodiode 1002 and an island-shaped semiconductor film of the transistor 1003 at the same time by processing (patterning) one semiconductor film deposited on the TFT substrate 1001 in a desired shape by etching or the like; therefore, a step generally added to a panel manufacturing process is unnecessary, achieving cost reduction.

A liquid crystal element 1005 includes a pixel electrode 1007, a liquid crystal 1008, and a counter electrode 1009. The pixel electrode 1007 is formed over the substrate 1001 and is electrically connected to the transistor 1003 and the storage capacitor 1004 via the conductive film 1010. Further, the counter electrode 1009 is formed over a substrate (a counter substrate) 1013, and the liquid crystal 1008 is sandwiched between the pixel electrode 1007 and the counter electrode 1009. Note that a transistor used for a photosensor, although not shown in FIG. 5, can be formed over the substrate (the TFT substrate) 1001 at the same time as the transistor 1003 in the process of manufacturing the transistor 1003.

A cell gap between the pixel electrode 1007 and the counter electrode 1009 can be controlled using a spacer 1016. Although the cell gap is controlled by the spacer 1016 which is selectively formed by photolithography and has a columnar shape in FIG. 5, the cell gap can alternatively be controlled by sphere spacers dispersed between the pixel electrode 1007 and the counter electrode 1009.

Further, between the substrate (TFT substrate) 1001 and the substrate (the counter substrate) 1013, the liquid crystal 1008 is surrounded by a sealing compound. Injection of the liquid crystal 1008 may be performed by a dispenser method (dripping method) or a dipping method (pumping method).

As the pixel electrode 1007, a light-transmitting conductive material, for example, indium tin oxide (ITO); indium tin oxide containing silicon oxide (ITSO); organoindium; organotin; zinc oxide (ZnO); indium zinc oxide (IZO) containing zinc oxide (ZnO); zinc oxide (ZnO) containing gallium (Ga); tin oxide (SnO₂); indium oxide containing tungsten oxide; indium zinc oxide containing tungsten oxide; indium oxide containing titanium oxide; indium tin oxide containing titanium oxide; or the like can be used.

In addition, since the liquid crystal element 1005 which is transmissive is shown as an example in this embodiment, the light-transmitting conductive materials described above can be used for the counter electrode 1009 like the pixel electrode 1007.

An alignment film 1011 is provided between the pixel electrode 1007 and the liquid crystal 1008, and an alignment film 1012 is provided between the counter electrode 1009 and the liquid crystal 1008. The alignment film 1011 and the alignment film 1012 can be formed using organic resin such as polyimide or polyvinyl alcohol, and have surfaces that have been subjected to alignment process, such as rubbing, for aligning liquid crystal molecules in a certain direction. Rubbing can be performed by rolling a roller wrapped with a nylon cloth or the like while pressure is applied to the alignment film and by rubbing a surface of the alignment film in a certain direction. Note that it is also possible to form the alignment films 1011 and 1012 that have orientation characteristics by using an inorganic material such as silicon oxide by an evaporation method, without alignment process.

Further, a color filter 1014 capable of transmitting light with a particular wavelength is formed over the substrate (counter substrate) 1013 so as to overlap with the liquid crystal element 1005. The color filter 1014 can be selectively formed by photolithography after the substrate 1013 is coated with an organic resin such as an acrylic resin in which pigments are dispersed. Alternatively, the color filter 1014 can be selectively formed as follows: the substrate 1013 is coated with a polyimide resin in which pigments are dispersed and then, etching is performed thereon. Alternatively, the color filter 1014 can be selectively formed by a droplet discharging method such as an ink jet method.

Further, a shielding film 1015 capable of shielding light is formed over the substrate (the counter substrate) 1013 so as to overlap with the photodiode 1002. The shielding film 1015 not only prevents light from the backlight that has passed through the substrate (the counter substrate) 1013 and has entered the touch panel from directly striking the photodiode 1002, but prevents disclination due to incorrect alignment of the liquid crystals 1008 between the pixels. The shielding film 1015 can be formed using an organic resin containing a black pigment such as a carbon black or titanium lower oxide whose oxidation number is smaller than that of titanium dioxide. Alternatively, a film using chrome can be used as the shielding film 1015.

Further, a polarizing plate 1017 is formed on the opposite side of the substrate (the TFT substrate) 1001 from the pixel electrode 1007, and a polarizing plate 1018 is formed on the opposite side of the substrate (the counter substrate) 1013 from the counter electrode 1009.

The liquid crystal element can include TN (twisted nematic) liquid crystals, VA (vertical alignment) liquid crystals, OCB (optically compensated birefringence) liquid crystals, IPS (in-plane switching) liquid crystals, or MVA (multi-domain vertical alignment) liquid crystals. Note that although the liquid crystal element 1005 with a structure where the liquid crystal 1008 is sandwiched between the pixel electrode 1007 and the counter electrode 1009 is shown as an example in this embodiment, a touch panel according to one embodiment of the present invention is not limited to this structure, that is, may be a liquid crystal element whose pair of electrodes is formed on the substrate (the TFT substrate) 1001 side as is the case of IPS liquid crystals.

In addition, although the case where a thin semiconductor film is used for the photodiode 1002, the transistor 1003, and the storage capacitor 1004 is shown as an example in this embodiment, a single crystal semiconductor substrate, an SOI substrate, or the like can alternatively be used.

In a cross-sectional structure shown in this embodiment, light from the backlight is shone from the substrate (the counter substrate) 1013 side, that is, shone on an object 1021 that is on the substrate (TFT substrate) 1001 side after passing through the liquid crystal element 1005 as shown by an arrow 1020. Then, light shown by the arrow 1022 and reflected off the object 1021 enters the photodiode 1002.

Here, in order for light of particular color (e.g., red (R), green (G), or blue (B)) to be detected by the photodiode 1002, light from the backlight shown by the arrow 1020 is needed to pass through the liquid crystal element 1005 in the pixel of the color and to be shone on the object on the substrate (the TFT substrate) 1001 side, and reflected light shown by an arrow 1022 is needed to enter the photodiode 1002 in the pixel. If the light from the backlight shown by the arrow 1020 passes through the liquid crystal element 1005 in a pixel of other color than the color and is shone on the object on the substrate (TFT substrate) 1001 side, and the reflected light shown by the arrow 1022 enters the photodiode 1002 in the pixel, light of unwanted color is mixed thereto. That is, the photodiode 1002 in the pixel detects the intensity of mixed light, making color imaging difficult.

For a liquid crystal panel or organic EL panel, a glass substrate is often used as the substrate (the TFT substrate) 1001 in general. Currently mass-produced liquid crystal panels or organic EL panels each have a glass substrate with the thickness of approximately 0.5 to 0.7 mm in many cases. On the other hand, the pixel size is less than 100 μm in the case of a high definition panel. In the case of a color filter method, pixel spacing of one-third the pixel size, that is, several tens of micrometers is applied to pixels of each color when the pixels are arranged in stripes.

In order for the light from the backlight shown by the arrow 1020 to pass through the liquid crystal element 1005 in the pixel of the color and to be shone on the object 1021 on the substrate (the TFT substrate) 1001 side, and in order for the reflected light shown by the arrow 1022 to enter the photodiode 1002 in the pixel, the light is allowed to extend only several tens of micrometers while going and coming 1.0 to 1.4 mm of way in the substrate (the TFT substrate) 1001. In other words, the aspect ratio becomes 30 to 50 or more, so that the light is needed to travel in very straight lines.

Therefore, this embodiment uses a field-sequential method: the light shown by the arrow 1022, which has been reflected off the object 1021 is detected by the photodiode 1002 during the backlight emits light of a particular color (e.g., red (R), green (G), or blue (B)). Then, after the lights of the colors are separately detected, they are combined to make one image, which leads to obtainment of color gradation. Thus, color gradation is easily obtained.

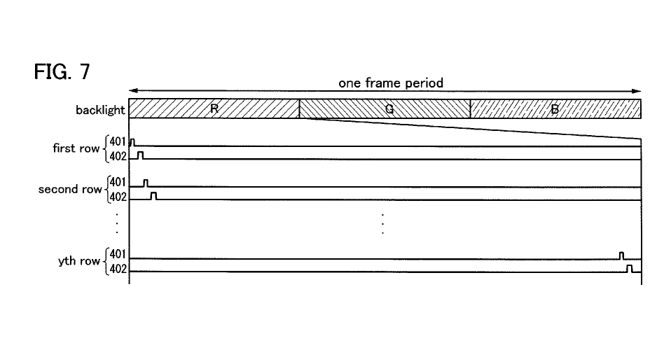

Reading operation of the photosensor and operation of the light source of each color included in the backlight in the case of a field-sequential method are described with reference to a timing chart in FIG. 7. For example, in the case where the backlight has a light source that provides red (R) light to the pixels, a light source that provides green (G) light to the pixels, a light source that provides blue (B) light to the pixels, the field-sequential method makes the above light sources to be sequentially turned on in one frame period.

Then, in the period where light of each color is provided to the pixels, the pixels sequentially operate row to row according to the timing chart in FIG. 4, obtaining image data per color. FIG. 7 illustrates a timing chart in terms of the signal 401 of the photodiode reset signal line 208 of pixels in each row, and in terms of the signal 402 of the gate signal line 209 of pixels in each row, to which the gate of the transistor 206 is connected.

For image display, a light source that provides red (R) light to the pixel, a light source that provides green (G) light to the pixel, and a light source that provides blue (B) light to the pixel are concurrently turned on, which makes it possible to provide white light to the panel.

Note that a color filter is not needed if an image is displayed by the field-sequential method in the case of using an imaging method according to this embodiment. Further, the definition of image display is improved because the pixels are not needed to be allocated according to the particular colors (e.g., red (R), green (G), and blue (B)).

On the other hand, the color filter method is effective in the image display in the case where the frame frequency of the imaging is approximately the same as or higher than the frame frequency of the image display. This is because respective lights of the particular colors (e.g., red (R), green (G), and blue (B)) of the backlight sequentially lit for imaging can be visually identified as white light with respect to the image display if the lighting speed is fast. In this case, it is effective in reducing power consumption because the operation frequency of the display element control circuit can be lowered.

Further, by providing a color filter to each pixel and controlling transmittivity of liquid crystal elements of every pixel corresponding to individual color, the field-sequential method enables obtainment of image data without switching the light source even if the light sources included in the backlight emit white light. This easily achieves a structure in which a part of the display region is an image area.

According to this embodiment, it is possible to provide an inexpensive touch panel capable of high-speed color imaging with high resolution. Further, it is possible to provide a driving method of an inexpensive touch panel capable of high-speed color imaging with high resolution.

### Embodiment 2

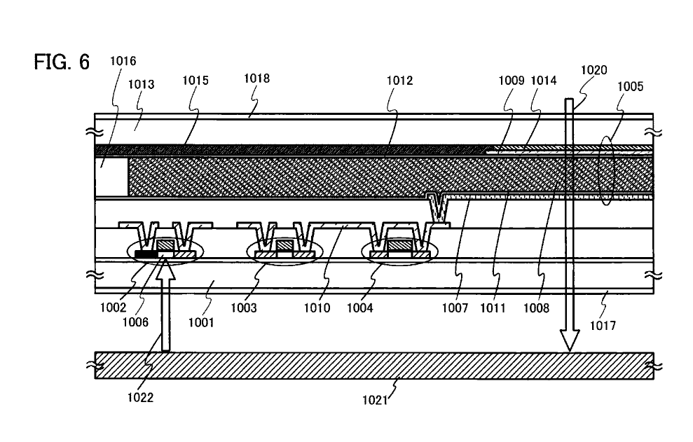

FIG. 6 illustrates a cross-sectional view of a touch panel different from that in Embodiment 1. In the touch panel shown in FIG. 6, the photodiode 1002 differs from that in FIG. 5 in having a shielding film formed using a conductive film that is used for a gate electrode of the transistor 1003. By the shielding film in the photodiode 1002, light from the backlight is prevented from directly entering a region that has i-type conductivity (i-type layer) and only light reflected off the object can be efficiently detected.

Further, in the case where the photodiode 1002 serves as a lateral PIN diode, a region that has p-type conductivity (a p-type layer) and a region that has n-type conductivity (n-type layer) can be self-aligned by using the shielding film as a mask. This is effective in manufacturing a small photodiode, in reducing the pixel size, and in improving the aperture ratio.

According to this embodiment, it is possible to provide an inexpensive touch panel capable of high-speed color imaging with high resolution. Further, it is possible to provide a driving method of an inexpensive touch panel capable of high-speed color imaging with high resolution.

### Example 1

In this example, the arrangement of a panel and light sources in a touch panel according to the present invention will be described.

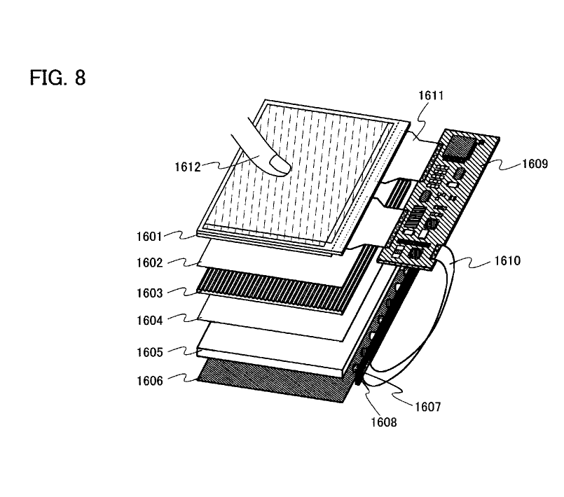

FIG. 8 illustrates an example of a perspective view showing the structure of a touch panel according to one embodiment of the present invention. A touch panel shown in FIG. 8 includes a panel 1601 in which a pixel including a liquid crystal element, a photodiode, a thin film transistor, and the like is formed between a pair of substrates; a first diffuser plate 1602; a prism sheet 1603; a second diffuser plate 1604; a light guide plate 1605; a reflector plate 1606; a backlight 1608 including a plurality of light sources 1607; and a circuit board 1609.

The panel 1601, the first diffuser plate 1602, the prism sheet 1603, the second diffuser plate 1604, the light guide plate 1605, and the reflector plate 1606 are stacked in the order presented. The light sources 1607 are provided at an end portion of the light guide plate 1605. Light from the light sources 1607 diffused into the light guide plate 1605 is uniformly shone from the counter substrate side on the panel 1601 with the help of the first diffuser plate 1602, the prism sheet 1603, and the second diffuser plate 1604.

Although the first diffuser plate 1602 and the second diffuser plate 1604 are used in this example, the number of diffuser plates is not limited thereto, that is, may be one, or may be three or more. The diffuser plate may be provided between the light guide plate 1605 and the panel 1601. Therefore, the diffuser plate may be provided only on the side closer to the panel 1601 than the prism sheet 1603, or may be provided only on the side closer to the light guide plate 1605 than the prism sheet 1603.

Further, the shape of the cross section of the prism sheet 1603, which is shown in FIG. 8, is not only serrate; the shape may be a shape with which light from the light guide plate 1605 can be gathered to the panel 1601 side.

The circuit board 1609 is provided with a circuit for generating or processing various signals to be input to the panel 1601, a circuit for processing various signals to be output from the panel 1601, and the like. In addition, in FIG. 8, the circuit board 1609 and the panel 1601 are connected to each other via an FPC (flexible printed circuit) 1611. Note that the above circuit may be connected to the panel 1601 by a chip on glass (COG) method, or part of the above circuit may be connected to the FPC 1611 by a chip on film (COF) method.

FIG. 8 illustrates an example in which a control circuit for controlling the driving of the light sources 1607 is provided for the circuit board 1609, and the control circuit and the light sources 1607 are connected to each other via the FPC 1610. However, the above described control circuit may be formed over the panel 1601, and in that case, the panel 1601 and the light sources 1607 are made to be connected to each other via an FPC or the like.

Note that although FIG. 8 illustrates an edge-lit type touch panel in which the light sources 1607 are provided on the edge of the panel 1601, a touch panel according to the present invention may be a direct type touch panel in which the light sources 1607 are provided directly below the panel 1601.

For example, when a finger 1612, an object, gets close to the panel 1601 from the TFT substrate side, part of light that passes through the panel 1601 from the backlight 1608 reflects off the finger 1612 and enters the panel 1601 again. Color image data of the finger 1612, the object, can be obtained by sequentially lighting the light sources 1607 that correspond to individual colors and obtaining image data of every color.

This example can be implemented in combination with any of the above described embodiments as appropriate.

### Example 2

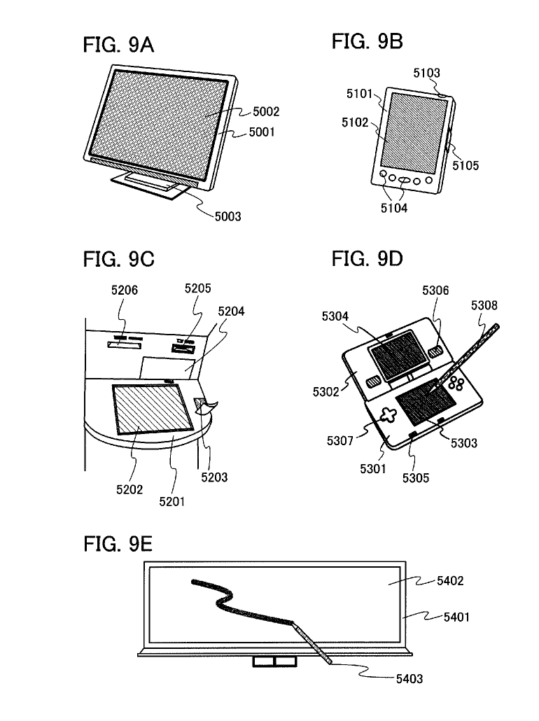

A touch panel according to one embodiment of the present invention is characterized by obtaining image data with high resolution. Therefore, an electronic device using the touch panel according to one embodiment of the present invention can be equipped with a higher-performance application by adding the touch panel as a component. A touch panel according to one embodiment of the present invention can be used for display devices, laptop computers, and image reproducers provided with recording media (typically devices that reproduce the content of recording media such as DVDs (digital versatile disc) and have displays for displaying the reproduced images). Besides, examples of the electronic device to which a touch panel according to the present invention is applicable include portable telephones, portable game consoles, personal digital assistants, e-book readers, cameras such as video cameras or digital still cameras, display goggles (head-mounted displays), navigation systems, audio systems (car audio systems, digital audio players, or the like), copying machines, facsimiles, printers, versatile printers, automated teller machines (ATMs), and vending machines. Specific examples of these electronic devices are shown in FIGS. 9A to 9E.

FIG. 9A illustrates a display device that includes a housing 5001, a display portion 5002, a support 5003, and the like. A touch panel according to one embodiment of the present invention can be used for the display portion 5002. The use of a touch panel according to one embodiment of the present invention for the display portion 5002 can provide a display device capable of obtaining image data with high resolution and capable of being equipped with higher-performance applications. Note that examples of the display device include all the information display devices used for personal computers, TV broadcast reception, advertisement display, or the like.

FIG. 9B illustrates a personal digital assistant that includes a housing 5101, a display portion 5102, a switch 5103, operation keys 5104, an infrared port 5105, and the like. A touch panel according to one embodiment of the present invention can be used for the display portion 5102. The use of a touch panel according to one embodiment of the present invention for the display portion 5102 can provide a personal digital assistant capable of providing image data with high resolution and being equipped with higher-performance applications.

FIG. 9C illustrates an automated teller machine that includes a housing 5201, a display portion 5202, a coin slot 5203, a paper money slot 5204, a card slot 5205, a passbook slot 5206, and the like. A touch panel according to one embodiment of the present invention can be used for the display portion 5202. The use of a touch panel according to one embodiment of the present invention for the display portion 5202 can provide an automated teller machine capable of providing image data with high resolution and being equipped with higher-performance applications. An automated teller machine using a touch panel according to one embodiment of the present invention can read, with higher precision, biological information used for biometric authentication, such as a fingerprint, a face, a hand print, a palm print, a hand vein pattern, or an iris. Therefore, a false reject rate that is a probability that the biometric authentication system identifies a user as another person, and a false accept rate that is a possibility that the biometric authentication system identifies another person as a user can be lowered.

FIG. 9D illustrates a portable game console that includes a housing 5301, a housing 5302, a display portion 5303, a display portion 5304, a microphone 5305, a speaker 5306, an operation key 5307, a stylus 5308, and the like. A touch panel according to one embodiment of the present invention can be used for the display portions 5303 and 5304. The use of a touch panel according to one embodiment of the present invention for the display portion 5303 or the display portion 5304 can provide a portable game console capable of providing image data with high resolution and being equipped with higher-performance applications. Note that although the portable game console shown in FIG. 9D includes two display portions, the display portions 5303 and 5304, the number of display portions included in the portable game console is not limited thereto.

FIG. 9E illustrates an electronic board that includes a housing 5401, a drawing area 5402, and the like. For the electronic board, information such as a character or a picture can be written at the drawing area 5402 with the use of the stylus 5403 or a marker using solvent ink. Further, the electronic board can convert information written at the drawing area into electronic data by using a photosensor. In the case of using the stylus 5403, information written at the drawing area 5402 is displayed at the drawing area 5402 by a display element after being converted into electronic data by the photosensor. A touch panel according to one embodiment of the present invention can be used for the drawing area 5402. The use of a touch panel according to one embodiment of the present invention for the drawing area 5402 can provide an electronic board capable of providing image data with high resolution and being equipped with higher-performance applications.

This example can be implemented in combination with any of the above described embodiments and example as appropriate.

This application is based on Japanese Patent Application serial no. 2009-157474 filed with Japan Patent Office on Jul. 2, 2009, the entire contents of which are hereby incorporated by reference.

What is claimed is:

1. A touch panel comprising:
a panel comprising a first substrate and a second substrate opposed to each other;
a plurality of light sources providing, from the first substrate side, lights of different wavelength regions to the panel; and
a plurality of pixels each comprising a liquid crystal element, a photodiode, and a thin film transistor provided between the first substrate and the second substrate,
wherein an island shaped semiconductor film included in the photodiode and an island shaped semiconductor film included in the thin film transistor are formed by etching one semiconductor film over the second substrate.

2. The touch panel according to claim 1, wherein a plurality of color filters is provided between the first substrate and the second substrate.

3. The touch panel according to claim 1, wherein the plurality of light sources comprises a light source that provides red light, a light source that provides blue light, and a light source that provides green light.

4. The touch panel according to claim 1, wherein the thin film transistor is included in a display element.

5. The touch panel according to claim 1, wherein the thin film transistor and a storage capacitor are electrically connected to a pixel electrode formed over the second substrate.

6. The touch panel according to claim 1, wherein a display element includes light emitting diodes.

7. The touch panel according to claim 1, wherein a display element includes organic light emitting diodes.

8. The touch panel according to claim 1, wherein the photodiode and a transistor are formed on an SOI substrate.

9. A touch panel comprising:
a panel comprising a first substrate and a second substrate opposed to each other;
a plurality of light sources providing, from the first substrate side, lights of different wavelength regions to the panel; and
a plurality of pixels each comprising a liquid crystal element, a photodiode, and a thin film transistor provided between the first substrate and the second substrate,
wherein an island shaped semiconductor film included in the photodiode and an island shaped semiconductor film included in the thin film transistor are formed by etching one semiconductor film over the second substrate, and
wherein a shielding film formed over the first substrate overlaps with the photodiode.

10. The touch panel according to claim 9, wherein a plurality of color filters is provided between the first substrate and the second substrate.

11. The touch panel according to claim 9, wherein the plurality of light sources comprises a light source that provides red light, a light source that provides blue light, and a light source that provides green light.

12. The touch panel according to claim 9, wherein the thin film transistor is included in a display element.

13. The touch panel according to claim 9, wherein the thin film transistor and a storage capacitor are electrically connected to a pixel electrode formed over the second substrate.

14. The touch panel according to claim 9, wherein a display element includes light emitting diodes.

15. The touch panel according to claim 9, wherein a display element includes organic light emitting diodes.

16. The touch panel according to claim 9, wherein the photodiode and a transistor are formed on an SOI substrate.

17. A touch panel comprising:
a panel comprising a first substrate and a second substrate opposed to each other;
a plurality of light sources providing, from the first substrate side, lights of different wavelength regions to the panel; and
a plurality of pixels each comprising a liquid crystal element, a photodiode, and a thin film transistor provided between the first substrate and the second substrate,
wherein an island shaped semiconductor film included in the photodiode and an island shaped semiconductor film included in the thin film transistor are formed by etching one semiconductor film over the second substrate, and
wherein a shielding film formed over the photodiode and a gate electrode included in the thin film transistor are formed by etching one conductive film over the second substrate.

18. The touch panel according to claim 17, wherein a plurality of color filters is provided between the first substrate and the second substrate.

19. The touch panel according to claim 17, wherein the plurality of light sources comprises a light source that provides red light, a light source that provides blue light, and a light source that provides green light.

20. The touch panel according to claim 17, wherein the thin film transistor is included in a display element.

21. The touch panel according to claim 17, wherein the thin film transistor and a storage capacitor are electrically connected to a pixel electrode formed over the second substrate.

22. The touch panel according to claim 17, wherein a display element includes light emitting diodes.

23. The touch panel according to claim 17, wherein a display element includes organic light emitting diodes.

24. The touch panel according to claim 17, wherein the photodiode and a transistor are formed on an SOI substrate.

25. A method of driving a touch panel which comprises a first substrate; a second substrate; a panel comprising, between the first substrate and the second substrate opposed to each other, a liquid crystal element, a photodiode, and a thin film transistor; an island shaped semiconductor film included in the photodiode and an island shaped semiconductor film included in the thin film transistor formed by etching one semiconductor film over the second substrate; the method comprising
providing lights of different wavelength regions to the panel from the first substrate side,
shining, on the photodiode, the lights reflected off an object on the second substrate side after the lights passed through the liquid crystal element, and
making the photodiode generate an electric signal in accordance with an intensity of the lights.

26. The method of driving a touch panel according to claim 25, wherein a plurality of color filters is provided between the first substrate and the second substrate.

27. The method of driving a touch panel according to claim 25, wherein a plurality of light sources comprises a light source that provides red light, a light source that provides blue light, and a light source that provides green light.

28. The method of driving a touch panel according to claim 25, wherein the thin film transistor is included in a display element.

29. The method of driving a touch panel according to claim 25, wherein the thin film transistor and a storage capacitor are electrically connected to a pixel electrode formed over the second substrate.

30. The method of driving a touch panel according to claim 25, wherein a display element includes light emitting diodes.

31. The method of driving a touch panel according to claim 25, wherein a display element includes organic light emitting diodes.

32. The method of driving a touch panel according to claim 25, wherein the photodiode and a transistor are formed on an SOI substrate.
